(19) United States
(12) Patent Application Publication
(10) Pub. No.: US 2007/0136598 A1
(43) Pub. Date: Jun. 14, 2007

(54) Image input and output device, client device, information processing method, and program storage medium

(76) Inventor: Norio Endo, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/438,608

(22) Filed: May 22, 2006

(30) Foreign Application Priority Data
Dec. 12, 2005 (JP) 2005-357265

(51) Int. Cl. H04L 9/00

(52) U.S. Cl. 713/176

(57) ABSTRACT

An image input and output device transfers data to and from a client device using a mailbox. The image input and output device includes a certificate receiving section and a mailbox creating section. The certificate receiving section receives, from the client device, an electronic certificate of a user that is stored in the client device. After the electronic certificate is received by the certificate receiving section, the mailbox creating section creates a mailbox for the user in a storage area in the image input and output device in accordance with the electronic certificate.

### PRIORITY INFORMATION

This application claims priority to Japanese Patent Application No. 2005-357265, filed on Dec. 12, 2005, which is incorporated herein by reference in its entirety.

### BACKGROUND

1. Technical Field

The present invention relates to an image input and output device, a client device, an information processing method, and a program.

2. Related Art

In recent years, image input and output devices such as a multifunction machine having copying, scanning, and printing functions are used not only for printing scanned image data by means of an integrated printer, or for printing documents transmitted from a personal computer (hereinafter, simply referred to as “PC”), but are also utilized as an image server.

For example, such machines have the functions of storing scanned image data in a mailbox assigned to each user, and, as needed, allowing a desired image to be retrieved remotely over a local area network (LAN). For such storage of image data, hard drives or other devices are used as an external memory device that can store a relatively large amount of data.

Creation of a mailbox for use in storing documents in an image input and output device has been inconvenient because it is necessary to input a name of a mailbox, a password, and other information at an operation panel of the image input and output device. As the use of a mailbox becomes more and more common, demands for simplifying the creation of a mailbox have been increased.

### SUMMARY

According to one aspect of the present invention, there is provided an image input and output device that transfers data to and from a client device using a mailbox. The image input and output device includes a certificate receiving section that receives, from the client device, an electronic certificate of a user that is stored in the client device; and a mailbox creating section that creates, after the electronic certificate is received by the certificate receiving section, a mailbox for the user in a storage area in the image input and output device in accordance with the electronic certificate.

### BRIEF DESCRIPTION OF THE DRAWINGS

An exemplary embodiment of the present invention will be described in detail based on the following figures, wherein:

FIG. 1 is a block diagram showing an overall structure of an information processing system according to a preferred embodiment of the present invention;

FIG. 2 is a block diagram showing a structure of an image input and output device according to a preferred embodiment of the present invention;

FIG. 3 is a block diagram showing a structure of a client device according to a preferred embodiment of the present invention;

FIG. 4 is an illustrative diagram showing a process flow in which a printer or scanner driver of a client device creates a mailbox in a storage area of an image input and output device according to a preferred embodiment of the present invention;

FIG. 5 is an illustrative diagram showing a process flow in which a printer or scanner driver stores data in a mail box created in an image input and output device according to a preferred embodiment of the present invention;

FIG. 6 is an illustrative diagram showing a process flow in which a printer or scanner driver transmits, to a client device, data obtained by an image input and output device according to a preferred embodiment of the present invention;

FIG. 7 is an image diagram showing an image of a print setting screen according to a preferred embodiment of the present invention; and

FIG. 8 is an image diagram showing an image of a print setting screen according to a preferred embodiment of the present invention.

### DETAILED DESCRIPTION

An exemplary embodiment of the present invention (hereinafter, referred to as “embodiment”) will be described below with reference to the drawings.

1. Overall Structure

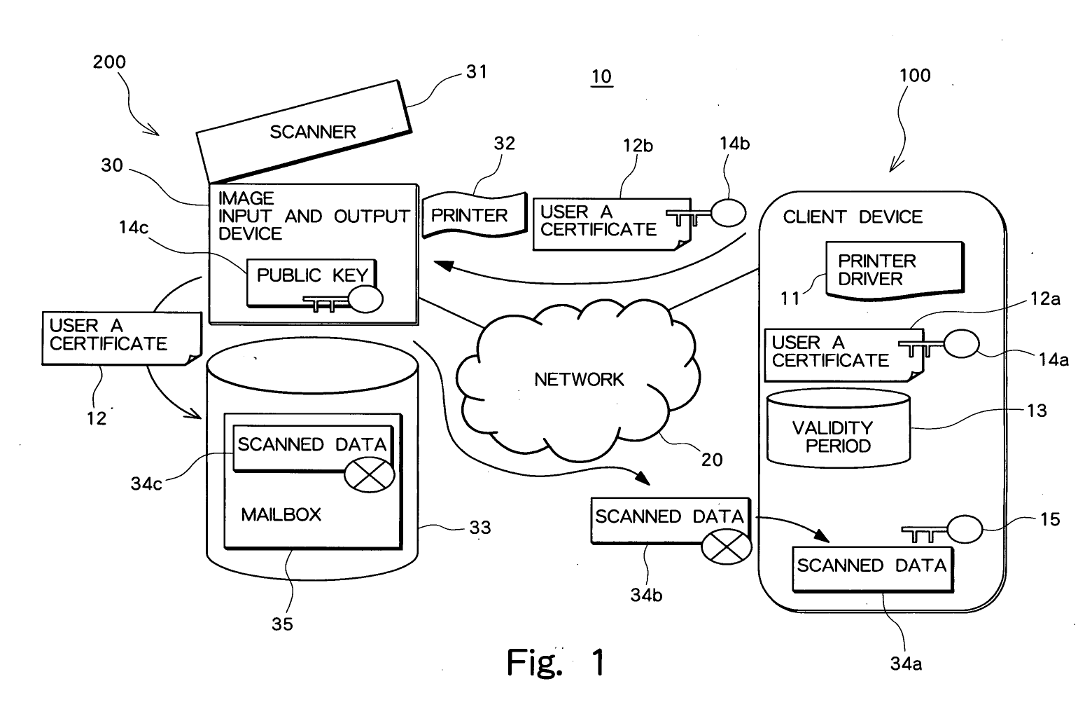

The general outlines of an information processing system will be described below with reference to the block diagram of an information processing system 10 shown in FIG. 1. The information processing system includes a client device 100 and an image input and output device 200, both of which are connected to a network 20.

The client device 100 is a PC used by a user (for example, user A), and includes a printer driver 11 that plays an essential role in creating and administering a mailbox, a user A certificate 12a that is an electronic certificate of the user A, and a period storage area 13 that administers a validity period of the electronic certificate.

The image input and output device 200 is a multifunction machine that has at least one function of a printer 32 and a scanner 31. The image input and output device 200 stores therein a public key 14c for the user A, and creates a mailbox 35 in a storage area 33 in accordance with a mailbox creation instruction transmitted from the client device 100. Further, the image input and output device 200 has the functions of obtaining a public key 14a added to the user A certificate 12a from the client device 100 via the network 20, and encrypting data to be stored in the mailbox 35. Further, the client device 100 has the functions of obtaining data encrypted by a public key 14c from the mailbox 35, and decrypting the data using a private key 15.

2. Structure of Image Input and Output Device

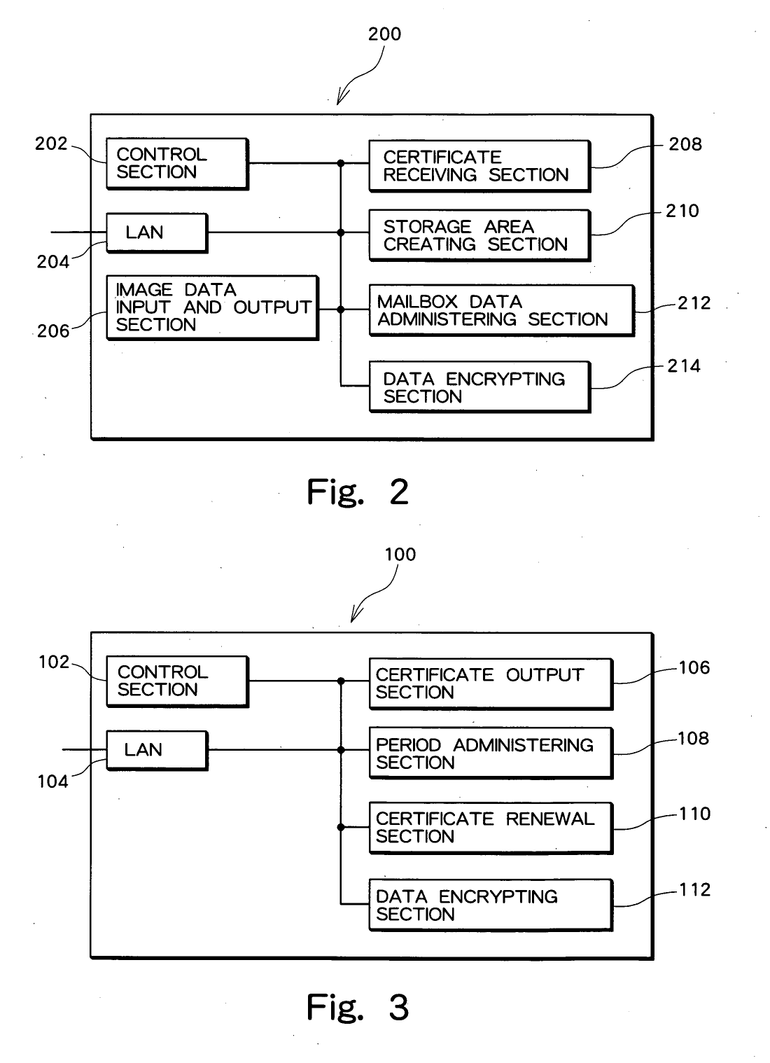

Next, the internal structure of the image input and output device 200 will be described with reference to FIG. 2. The image input and output device 200 includes an image data input and output section 206, a certificate receiving section 208, a storage area creating section 210, a mailbox data administering section 212, a data encrypting section 214, a LAN interface 204, and a control section 202. These sections and the LAN interface 204 are connected to and controlled by the control section 202.

More specifically, the control section 202 controls the image data input and output section 206 that functions as a fax, a printer, a scanner, or the like, the LAN interface 204 for providing a connection to a network, the certificate receiving section 208 for receiving an electronic certificate from the client device 100, the storage area creating section 210 that creates a mailbox or other areas in a hard drive or a non-volatile memory (not shown) provided in the image input and output device 200, the mailbox data administering section 212 that inputs and outputs data to and from a mailbox, and administers data stored in the mailbox, and the data encrypting section 214 that encrypts data to be stored in the mailbox.

3. Structure of Client Device

The internal structure of the client device 100 will be described with reference to FIG. 3. The client device 100 includes a LAN interface 104, a certificate output section 106, a period administering section 108, a certificate renewal section 110, a data encrypting section 112, and a control section 102. As in the image input and output device 200, these sections and the LAN interface 104 are connected to the control section 102.

The control section 102 is capable of storing, in an internal storage area provided in the client device 100, an electronic certificate obtained from a certification server such as a directory server (not shown), and outputting the electronic certificate to the image input and output device 200 through the certificate output section 106. Further, the period administering section 108 and the certificate renewal section 110 are provided to administer a mailbox synchronized with the electronic certificate.

Further, the data encrypting section 112 of the client device 100 has the function of encrypting document data to be transmitted to the image input and output device 200 using document processing software. The control section 102 is capable of controlling the respective sections and the LAN interface 104 to perform processing. It should be noted that the client device 100 is a PC used by a typical user, and most of the functions are achieved by a program.

4. Process of Creating Mailbox

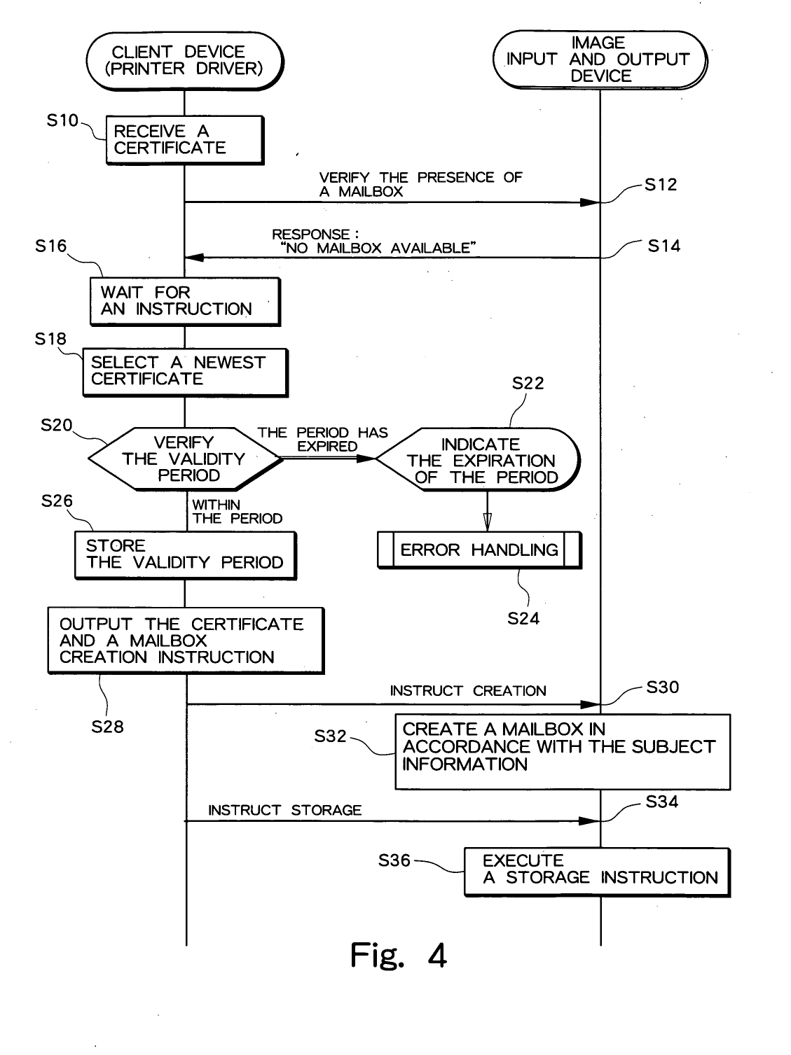

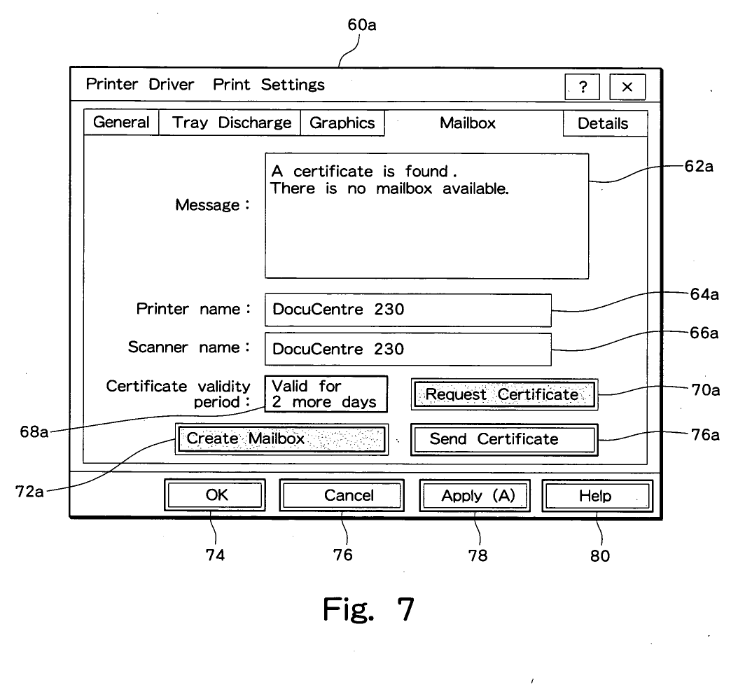

FIG. 4 is an illustrative diagram showing a flow of a process performed by an information processing system in which a mailbox for a user is created in the image input and output device 200. FIG. 7 shows a screen image of the printer driver of the client device 100 that is used for creating a mailbox.

According to the embodiment of the present invention, the printer driver of the client device 100 has a “Create Mailbox” button for creating a mailbox in the image input and output device 200 using an electronic certificate, as shown in FIG. 7, and the printer driver is connected to the image input and output device 200 through a connection port on the client device 100. Further, because an electronic certificate includes subject information, such as a user name that identifies the user, and a password, a mailbox can be created based on the electronic certificate.

For example, in a case where an electronic certificate is stored in the client device 100, and a mailbox is not created in the image input and output device 200, when a user opens a “Mailbox” tag on the printer driver screen 60 as shown in FIG. 7, the printer driver program of the client device 100 is activated, and the driver program verifies whether or not the client device 100 has retrieved an electronic certificate at step 10 shown in FIG. 4, and verifies a validity period of the retrieved electronic certificate. Next, the printer driver inquires of the image input and output device 200 as to whether or not a mailbox for the user A is present (step S12), and receives a response indicating “no mailbox available” from the image input and output device 200 (step S14).

In response to such information, as shown in FIG. 7, a message box 62a displays that “A certificate is found. There is no mailbox available”, a certificate validity period box 68a displays information such as, for example, “Valid for 2 more days”, and the process enters step S16 to wait for an instruction.

If the user has two or more certificates, it is possible to select a newest certificate at step S18. Then, the validity period of the certificate is determined at step S20. If the period has expired, the screen displays, at step S22, a notice notifying the user of the expiration of the period, and the process transfers to error handling (step S24), such as a step of obtaining another certificate, or outputting an image, for example, directly to the printer without using a mailbox. If, at step S20, it is determined that it is within the period, information regarding the validity period is stored in a storage area in the client device 100 (step S26), and is used to administer the mailbox.

Next, when the user presses a “Create Mailbox” button 72a shown in FIG. 7, the client device 100 transmits the electronic certificate and a mailbox creation instruction to the image input and output device 200 (step S28). After receiving the creation instruction (step S30), the image input and output device 200 creates (step S32) a mailbox in accordance with subject information (a user name, a password, and other information) which is user information attached to the electronic certificate, and performs setting of encryption using the public key 14 of the electronic certificate. Setting of a mailbox is completed through the above-described steps.

Next, the user instructs storage of document data in the created mailbox (step S34). After receiving the storage instruction from the printer driver, the image input and output device 200 receives and then stores document data encrypted by the client device 100 in the mailbox (step S36). It is also possible to store, in the mailbox, data captured through the scanner in the image input and output device 200.

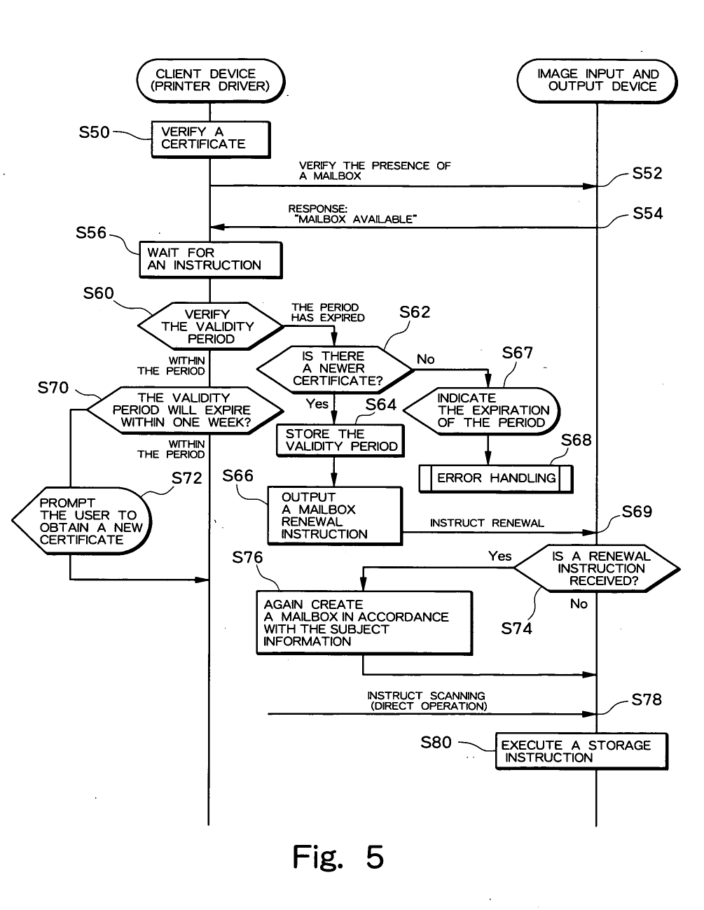

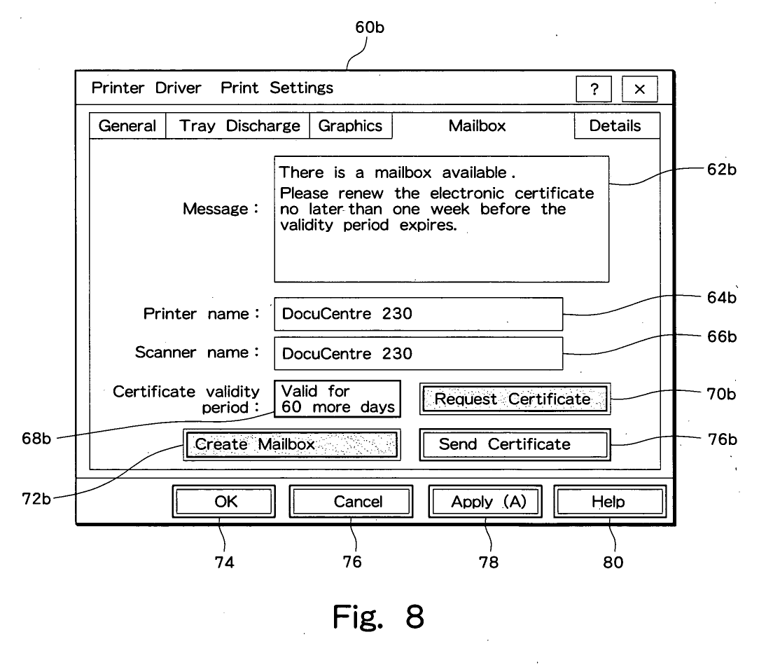

5. Process of Storing Data into Mailbox A flow of a process in which the information processing system reads an image using the scanner 31 of the image input and output device 200, and stores the read data in the mailbox, will be described with reference to FIGS. 5 and 8. FIG. 5 is an illustrative diagram showing a flow of a process for cases where a mailbox is already present. FIG. 8 is an image diagram showing a screen image of a printer driver.

First, a method by which a user verifies, before using the scanner, whether or not a mailbox is available through the client device 100, will be described. Availability of a mailbox for cases where the scanner is used can be verified in a manner similar to the case where the printer is used, i.e., by opening the printer driver screen as shown in FIG. 8.

After the printer driver screen is opened, the printer driver of the client device 100 verifies whether or not a correct electronic certificate has been obtained (steps S50 through S54). While the client device 100 is waiting for an instruction (step S56), the printer driver displays, in a message box 62b shown in FIG. 8, that “There is a mailbox. Please renew the electronic certificate no later than one week before the validity period expires”. Similarly, a box for the certificate validity period displays, for example, “Valid for 60 more days”, and a box for the scanner name shows, for example, a multifunction machine “DocuCentre 230”, as shown in FIG. 8.

Next, at step S60, the printer driver verifies the validity period. If the period has expired, it is determined at step S62 whether or not another (newer) electronic certificate is present in another directory, and if there is no certificate, the printer driver provides display indicating the expiration of the period (step S67). Then, error handling (step S68) is performed to ask the user to select processing or setting for a case where no mailbox is available.

If it is determined at step S62 that a newer electronic certificate is present in another directory, the printer driver performs a process for storing a new validity period (step S64). Then, the printer driver outputs a mailbox renewal instruction to the image input and output device (step S66). The image input and output device receives, at step S69, an electronic certificate that is output along with the renewal instruction. The image input and output device determines (step S74) whether or not a renewal instruction is received, and if it is determined that a renewal instruction is received, deletes the invalid mailbox and again creates a mailbox (step S76).

In verification of the validity period of the electronic certificate (step S60), if it is determined that the electronic certificate is within the validity period, it is further determined (step S70),whether or not the period will expire within one week. If it is determined that the period will expire within one week, the printer driver prompts (step S72) the user to obtain a new certificate because the electronic certificate will become invalid soon. This is because it usually takes several days until an application is processed and the user receives a new electronic certificate. Verification of the mailbox is completed through the above-described steps.

Next, the user operates the scanner of the image input and output device 200 to scan image data and store the scanned document data in the designated mailbox. Then, the image input and output device 200 performs an encrypting process to encrypt the document data using the public key of the electronic certificate, and stores the encrypted data in the mailbox (step S80).

6. Process of Reading Data from Mailbox

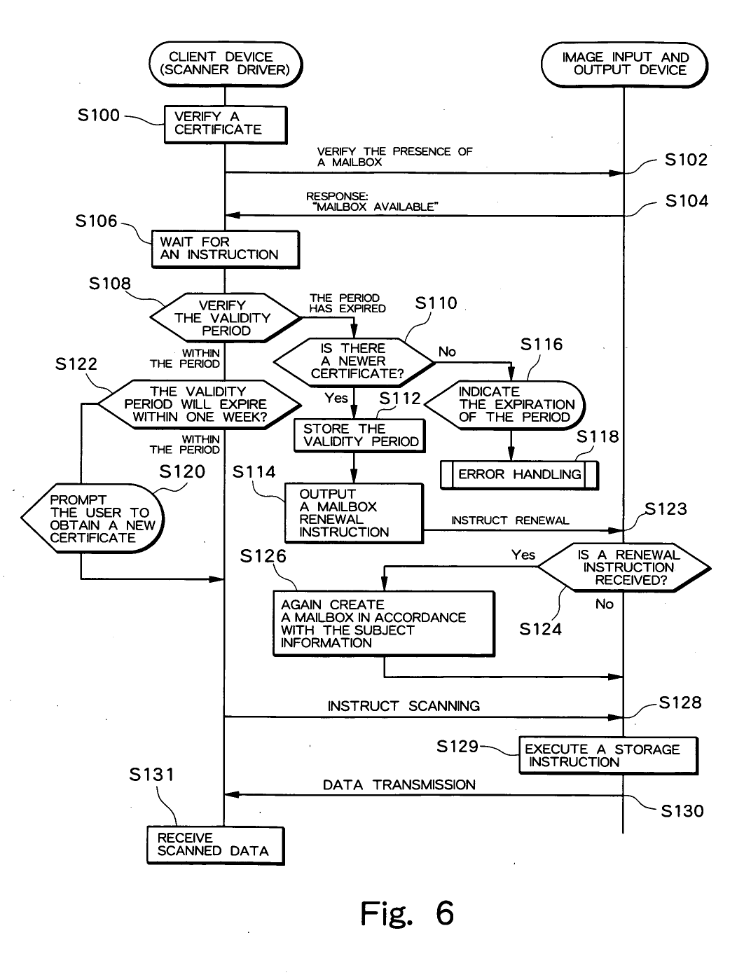

FIG. 6 shows a flow of a process in which the scanner driver of the client device 100 reads document data stored in a mailbox of the image input and output device 200. In the present embodiment, because an encrypting process using the public key of the electronic certificate is performed on the document data stored in the mailbox, it is necessary to use the private key of the electronic certificate in order to decrypt the document data.

For this reason, in the present embodiment, a process for verifying the certificate is performed through steps S100 to S120. In the following, description of steps similar to the steps described above with reference to FIG. 5 is not repeated here.

After step S120, when verification of validity of the electronic certificate is completed, the user inputs the user name and password that are identical to those used for the subject information of the electronic certificate through the client device to the image input and output device, selects document data stored in the mailbox, and causes the client device to output a read instruction. In response to the read instruction, the image input and output device transmits the encrypted document data to the client device 100 (step S130) Then, the client device 100 decrypts the received document data using the private key to obtain plain text document data (step S131). Reception of data is completed through the above-described steps.

What is claimed is:

1. An image input and output device that transfers data to and from a client device using a mailbox, the image input and output device comprising:
a certificate receiving section that receives, from the client device, an electronic certificate of a user that is stored in the client device; and
a mailbox creating section that creates, after the electronic certificate is received by the certificate receiving section, a mailbox for the user in a storage area in the image input and output device in accordance with the electronic certificate.

2. The image input and output device according to claim 1, further comprising an encrypting section that encrypts data to be stored in the mailbox using a public key included in the electronic certificate, wherein
the data encrypted by the encrypting section is stored in the mailbox, and the encrypted data is used for transfer between the image input and output device and the client device.

3. The image input and output device according to claim 1, further comprising:
a period information receiving section that receives validity period information of the electronic certificate from the client device; and
a mailbox renewal section that renews the mailbox in accordance with the validity period information received by the period information receiving section and the electronic certificate received from the client device.

4. A client device that transfers data to and from an image input and output device using a mailbox, the client device comprising:
a certificate output section that outputs, to the image input and output device, an electronic certificate of a user that is stored in the client device;
a period management section that manages a validity period of the electronic certificate; and
a certificate renewal section that provides notification to the user at least before the validity period expires to obtain a new electronic certificate.

5. An information processing method performed by an image input and output device that transfers data to and from a client device using a mailbox, the information processing method comprising:
receiving, from the client device, an electronic certificate of a user that is stored in the client device; and
creating, after the electronic certificate is received, a mailbox for the user in a storage area in the image input and output device in accordance with the electronic certificate.

6. The information processing method according to claim 5, further comprising encrypting data to be stored in the mailbox using a public key included in the electronic certificate, wherein the encrypted data is stored in the mailbox, and the encrypted data is used for transfer between the image input and output device and the client device.

7. The information processing method according to claim 4, further comprising:
receiving validity period information of the electronic certificate from the client device; and
renewing the mailbox in accordance with the validity period information and the electronic certificate received from the client device.

8. An information processing method performed by a client device that transfers data to and from an image input and output device using a mailbox, the information processing method comprising:
outputting, to the image input and output device, an electronic certificate of a user that is stored in the client device;
managing a validity period of the electronic certificate; and
providing notification to the user at least before the validity period expires to obtain a new electronic certificate.

9. A computer readable medium storing a program causing a computer to execute a process for transferring data to and from a client device using a mailbox, the process comprising:
receiving, from the client device, an electronic certificate of a user that is stored in the client device; and
creating, after the electronic certificate is received, a mailbox for the user in a storage area in the image input and output device in accordance with the electronic certificate.

10. The medium according to claim 9, the process further comprising:
encrypting data to be stored in the mailbox using a public key included in the electronic certificate.

11. A storage medium according to claim 7, the function further comprising:
receiving validity period information of the electronic certificate from the client device; and
renewing the mailbox in accordance with the validity period information and the electronic certificate received from the client device.

12. A computer readable medium storing a program causing a computer to perform a process for transferring data to and from an image input and output device using a mailbox, the process comprising:
outputting, to the image input and output device, an electronic certificate of a user that is stored in the client device;
administering a validity period of the electronic certificate; and
providing notification to the user at least before the validity period expires to obtain a new electronic certificate.
